(19) United States
(12) Patent Application Publication
(10) Pub. No.: US 2025/0238989 A1
(43) Pub. Date: Jul. 24, 2025

(54) TECHNIQUES FOR CHARACTER MOTION PLANNING

(71) Applicant: NVIDIA CORPORATION, Santa Clara, CA (US)

(72) Inventors: Chen TESSLER, Zichron Yaakov (IL); Assaf HALLAK, Tel Aviv (IL); Gal DALAL, Shimshit (IL); Gal CHECHIK, Tel Aviv (IL); Shie MANNOR, Haifa (IL)

(21) Appl. No.: 18/783,291

(22) Filed: Jul. 24, 2024

Related U.S. Application Data
(60) Provisional application No. 63/624,055, filed on Jan. 23, 2024.
(60) Provisional application No. 63/549,962, filed on Feb. 5, 2024.
(60) Provisional application No. 63/560,582, filed on Mar. 1, 2024.

(51) Int. Cl. G06T 13/40; G06T 7/20; G06T 17/00

(52) U.S. Cl. CPC G06T 13/40; G06T 7/20; G06T 17/00

(57) ABSTRACT

One embodiment of a method for controlling a character includes receiving a state of the character, a path to follow, and first information about a scene, generating, via a trained machine learning model and based on the state of the character, the path, and the first information, a first action for the character to perform, wherein the first action comprises a first type of motion included in a plurality of types of motions for which the trained machine learning model is trained to generate actions, and causing the character to perform the first action.

### CROSS-REFERENCE TO RELATED APPLICATIONS

This application claims priority benefit of the United States Provisional patent application titled, “TECHNIQUES FOR HUMANOID PATH AND MOTION PLANNING IN SIMULATED PHYSICAL ENVIRONMENTS,” filed on Jan. 23, 2024, and having Ser. No. 63/624,055; the United States Provisional patent application titled, “TECHNIQUES FOR HUMANOID PATH AND MOTION PLANNING IN SIMULATED PHYSICAL ENVIRONMENTS,” filed on Feb. 5, 2024, and having Ser. No. 63/549,962; and the United States Provisional patent application titled, “TECHNIQUES FOR HUMANOID PATH AND MOTION PLANNING IN SIMULATED PHYSICAL ENVIRONMENTS,” filed on Mar. 1, 2024, and having Ser. No. 63/560,582. The subject matter of these related applications are hereby incorporated herein by reference.

### BACKGROUND

### Technical Field

Embodiments of the present disclosure relate generally to robot and virtual character control, artificial intelligence (AI), and machine learning, and, more specifically, to techniques for character motion planning.

### Description of the Related Art

Motion planning in complex 3D environments is an advancing field of artificial intelligence that involves directing the actions of robots, such as humanoid robots, as the robots navigate through rich, dynamic scenes. Various approaches have been developed for instructing the robots on how to adapt to changes in the environment and avoid obstacles while carrying out navigational tasks. Motion planning typically includes both a path planning stage, which involves calculating a path from one point to another that avoids static obstacles within an environment, and a motion execution stage, in which the robot adapts the movements to the environment features and dynamic obstacles encountered along the planned path.

One conventional approach for motion planning uses physics-based techniques to compute motions for a robot given the kinematic and dynamic properties of that robot. The physics-based motion planning techniques can start from static pre-planned paths, which are paths programmed in advance based on an initial understanding of the environment. Given such static pre-planned paths, the physics-based motion planning techniques can, for example, use inverse kinematics to calculate joint angles for achieving desired positions and orientations of a robot end-effector, or use dynamic modeling to predict and control the forces and torques to achieve desired movements of the robot while adhering to the laws of physics.

One drawback of the above approach for motion planning is the reliance on static pre-planned paths can prevent the robot from adapting in real time to unforeseen changes in the environment. Accordingly, such an approach is oftentimes ineffective in dynamic or unpredictable scenarios where obstacles can appear spontaneously, or the terrain can change unexpectedly. In that regard, robots being controlled using the above approach can face difficulties in maintaining accuracy and fluidity of movements when encountering sudden environmental changes, such as debris falling in a rescue operation or unexpected human movements in customer service environments. When faced with sudden environmental changes, the above approach for motion planning often requires manual recalibration or reprogramming of paths, which can be time-consuming and impractical in fast-paced or emergency situations.

Another drawback of the above approach for motion planning is the generated motions are oftentimes not particularly realistic or naturally accurate. In that regard, the above approach can prioritize path efficiency and robotic precision over naturalistic movements, such as human-like movements. Consequently, the generated motions can appear mechanical, which is not always suitable for applications requiring high fidelity in natural motion simulation, such as in virtual reality or humanoid robotics intended for social interactions or entertainment purposes. In particular, the generated motions can include rigid, predefined movements that lack the subtle nuances and adaptability of natural (e.g. human-like) motion, making the robots less effective in roles that require interaction with humans, such as caregiving, where empathetic and context-aware responses are crucial.

As the foregoing illustrates, what is needed in the art are more effective techniques for motion planning.

### SUMMARY

One embodiment of the present disclosure sets forth a computer-implemented method for controlling a character. The method includes receiving a state of the character, a path to follow, and first information about a scene. The method further includes generating, via a trained machine learning model and based on the state of the character, the path, and the first information, a first action for the character to perform, where the first action comprises a first type of motion included in a plurality of types of motions for which the trained machine learning model is trained to generate actions. In addition, the method includes causing the character to perform the first action.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, a physical or virtual character can be controlled to adapt in real time to unforeseen changes in an environment, unlike conventional approaches that rely on static pre-planned paths. The disclosed techniques adjust to dynamic and unpredictable scenarios where obstacles can appear spontaneously, or terrain can change unexpectedly. Another technical advantage of the disclosed techniques is the ability to generate relatively realistic and naturally accurate motions of characters. Unlike conventional approaches that often generate mechanical and rigid movements, the disclosed techniques enable both path efficiency and human-like motion of characters. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer-based system configured to implement one or more aspects of the various embodiments;

FIG. 2 is a more detailed illustration of the machine learning server of FIG. 1, according to various embodiments;

FIG. 3 is a more detailed illustration of the model trainer of FIG. 1, according to various embodiments;

FIG. 4 is a more detailed illustration of the computing device of FIG. 1, according to various embodiments;

FIG. 5 is a more detailed illustration of the control application of FIG. 1, according to various embodiments;

FIG. 6 is a more detailed illustration of the path planner of FIG. 5, according to various embodiments;

FIG. 7 sets forth a flow diagram of method steps for training a motion policy model, according to various embodiments;

FIG. 8 sets forth a flow diagram of method steps for controlling a character based on a trained motion policy model, according to various embodiments; and

FIG. 9 is a flow diagram of method steps for generating a path using textual guidance and state information, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for controlling a character in an environment. The disclosed techniques include a training step and an inference step. In the training step, a motion policy model is trained in an iterative manner to generate motions for the character based on a given path segment from one landmark to another landmark. The training includes a discriminator and a reinforcement learning module acting in cooperation to train the motion policy model.

During the training, the reinforcement learning module generates a motion that is used to control the character in the environment and compute a path-following reward based on the character motion in the environment. The discriminator compares the character motion with stored motion recordings of human motions and generates an Adversarial Motion Prior (AMP) reward. A combination of the path-following and the AMP rewards is used to iteratively update both the motion policy model and the discriminator. Once the motion policy model is trained, in the inference step, a path planning technique is performed given an input textual guidance and environment scene to generate a path segment from a source landmark to a goal landmark. The trained motion policy model is then used to generate a motion based on the path segment while checking for collisions with dynamic obstacles. The generated motion can then be used to control the character in the environment, and the foregoing process continues until all target landmarks from the source landmark to the goal landmark are visited.

The techniques for controlling a character in an environment have many real-world applications. For example, those techniques could be used to control a physical robot in a real-world environment. As another example, those techniques could be used to control a character in a virtual or extended reality (XR) environment, such as a gaming environment. As a further example, those techniques can be used to control a character in a three-dimensional (3D) animation.

The above examples are not in any way intended to be limiting. As persons skilled in the art will appreciate, as a general matter, the techniques for controlling robots described herein can be implemented in any suitable application.

### System Overview

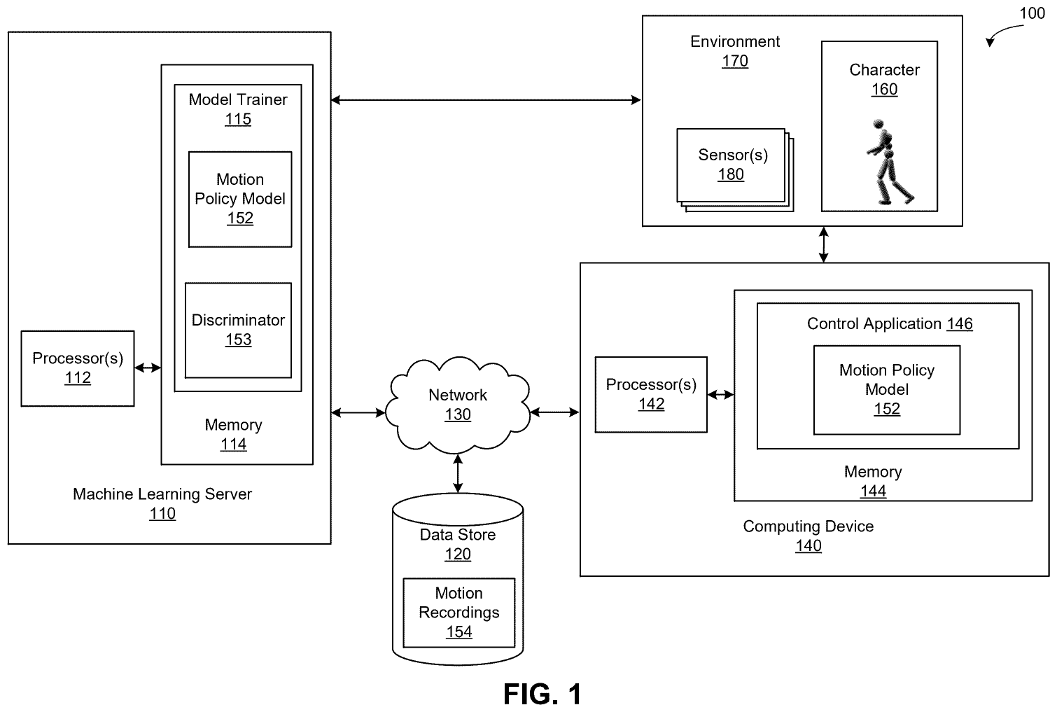

FIG. 1 illustrates a block diagram of a computer-based system 100 configured to implement one or more aspects of at least one embodiment. As shown, system 100 includes, without limitation, a machine learning server 110, a computing device 140, a data store 120, a network 130, and an environment 170. Machine learning server 110 includes, without limitation, one or more processors 112 and memory 114. Memory 114 includes, without limitation, a model trainer 115. Model trainer 115 includes, without limitation, a motion policy model 152 and a discriminator 153. Data store 120 includes, without limitation, motion recordings 154. Computing device 140 includes, without limitation, one or more processors 142 and memory 144. Memory 144 includes, without limitation, a control application 146. Environment 170 includes, without limitation, a character 160 and one or more sensors 180.

Machine learning server 110 shown herein is for illustrative purposes only, and variations and modifications are possible, without departing from the scope of the present disclosure. For example, the number of processors 112, the number of GPUs and/or other processing unit types, the number of and/or type of memories 114, and/or the number of applications included in the memory 114 can be modified as desired. Further, the connection topology between the various units in FIG. 1 can be modified as desired. In some embodiments, any combination of processor(s) 112, memory 114, and/or GPU(s) can be included in and/or replaced with any type of virtual computing system, distributed computing system, and/or cloud computing environment, such as a public, private, or a hybrid cloud system.

Processor(s) 112 can include any suitable processor(s), such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 112 can be any technically feasible hardware unit capable of processing data and/or executing software applications. During operation, processor(s) 112 receive user input from input devices (not shown), such as a keyboard or a mouse.

Memory 114 of computing device 110 stores content, such as software applications and data, for use by processor(s) 112. As shown, memory 114 includes model trainer 115. Memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 114. The storage can include any number and type of external memories that are accessible to processor(s) 112. For example, and without limitation, the storage can include a Secure Digital Card, an external Flash memory, a portable compact disc read-only memory (CD-ROM), an optical storage device, a magnetic storage device, and/or any suitable combination of the foregoing.

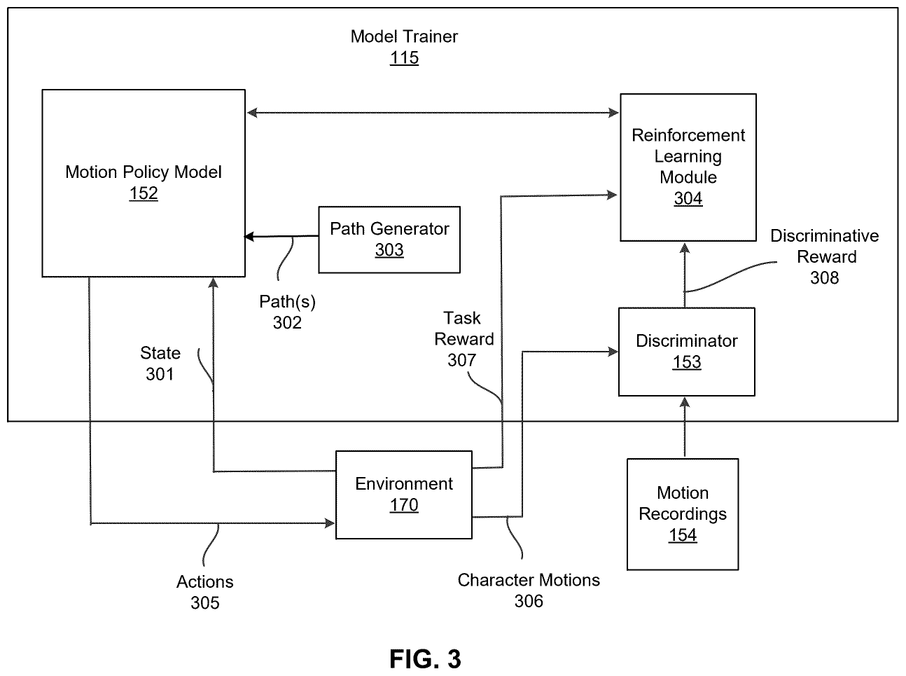

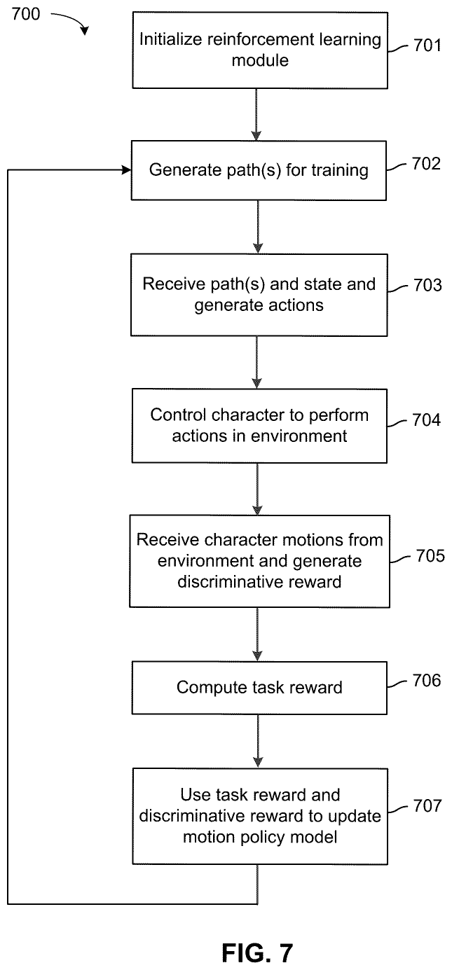

Model trainer 115 is stored in memory 114 and is executed by processor(s) 112. Model trainer 115 is configured to train one or more machine learning models, such as motion policy model 152 and discriminator 153, that, once trained, can be used to control a character, such as character 160, to perform a task. Model trainer 115 can employ any suitable techniques to train the machine learning model(s). For example, model trainer 115 can use supervised learning, unsupervised learning, reinforcement learning, deep learning, and/or the like to train the machine learning model(s). Model trainer 115 is discussed in greater detail below in conjunction with FIGS. 3 and 7.

Motion policy model 152 is a data-driven model that includes a set of parameters that have been optimized by model trainer 115 to assist in the generation of motions for character 160. For example, in some embodiments, motion policy model 152 can be a neural network. In various embodiments, the parameters of motion policy model 152 can be learned using backpropagation. In some embodiments, the parameters can be updated as new data becomes available, as the task requirements for character 160 evolve, as a user prompt is received from one or more I/O device(s) (not shown), or the like. Once trained, motion policy model 152 can be deployed in any suitable manner, such as via control application 146.

Data store 120 can include any storage device or devices, such as fixed disc drive(s), flash drive(s), optical storage, network attached storage (NAS), and/or a storage area-network (SAN). Although shown as accessible over network 130, in some embodiments machine learning server 110 can include data store 120. As shown, data store 120 includes motion recordings 154.

Motion recordings 154 are used for training and refining motion policy model 152 and discriminator 153. In some embodiments, motion recordings 154 include recorded motions of humans that are used to evaluate the generated motions of motion policy model 152. In various examples, motion recordings 154 are curated from various human activities that are, for example, collected through motion capture technologies. In some embodiments, motion recordings 154 are customized to the task that motion policy model 152 is supposed to generate motions for, such as basic locomotion tasks, to avoid unwanted behaviors and motions, such as back-flips and break-dancing. For example, motion recordings 154 could include a number of distinct motions from the Archive of Motion Capture as Surface Shapes (AMASS) dataset, specifically focusing on the four forms of locomotion of walking, running, jumping, and crawling, performed in various styles. Complementing the distinct motions from AMASS dataset, datasets such as HumanML3D can provide textual labels for each motion in AMASS dataset.

Network 130 can be a wide area network (WAN), such as the Internet, a local area network (LAN), a cellular network, and/or any other suitable network. Machine learning server 110, computing device 140, and data store 120 are in communication over network 130. For example, network 130 can include any technically feasible network hardware suitable for allowing two or more computing devices to communicate with each other and/or to access distributed or remote data storage devices, such as data store 120.

Computing device 140 shown herein is for illustrative purposes only, and variations and modifications are possible, without departing from the scope of the present disclosure. For example, the number of processors 142, the number of GPUs and/or other processing unit types, the number of memories 144, and/or the number of applications included in the memory 144 can be modified as desired. Further, the connection topology between the various units in FIG. 1 can be modified as desired. In some embodiments, any combination of processor(s) 142, memory 144, and/or GPU(s) can be included in and/or replaced with any type of virtual computing system, distributed computing system, and/or cloud computing environment, such as a public, private, or a hybrid cloud system.

Processor(s) 142 can include any suitable processor(s), such as a central processing unit (CPU), a graphics processing unit (GPU), an application-specific integrated circuit (ASIC), a field programmable gate array (FPGA), a digital signal processor (DSP), a multicore processor, and/or any other type of processing unit, or a combination of two or more of a same type and/or different types of processing units, such as a system on a chip (SoC), or a CPU configured to operate in conjunction with a GPU. In general, processors 142 can be any technically feasible hardware unit capable of processing data and/or executing software applications. During operation, processor(s) 142 receives user input from input devices (not shown), such as a keyboard or a mouse.

Memory 144 of computing device 140 stores content, such as software applications and data, for use by processor(s) 142. As shown, memory 144 includes robot control application 146. Memory 144 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 144. The storage can include any number and type of external memories that are accessible to processor(s) 142. For example, and without limitation, the storage can include a Secure Digital Card, an external Flash memory, a portable compact disc read-only memory (CD-ROM), an optical storage device, a magnetic storage device, and/or any suitable combination of the foregoing.

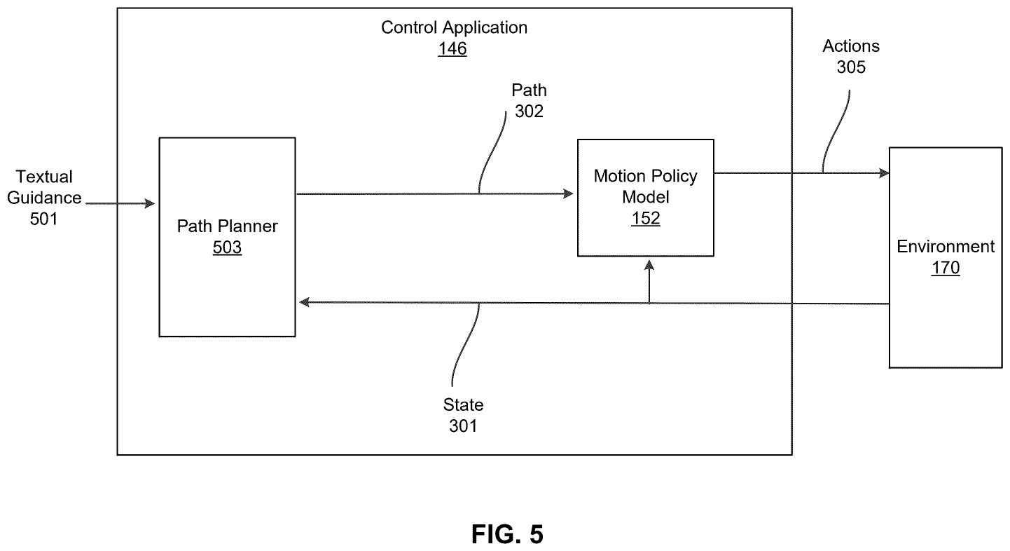

As shown, control application 146 that uses the trained motion policy model 152 is stored in memory 144, and executes on processor(s) 142. Control application 146 is discussed in greater detail below in conjunction with FIGS. 5-6 and 8-9. Illustratively, given sensor data captured by one or more sensors 180 (e.g., force sensors, cameras, and/or the like), control application 146 uses motion policy model 152 to control character 160 to perform one or more tasks, for which motion policy model 152 was trained, in environment 170.

Environment 170, in which character 160 performs tasks, can be either virtual or physical. In a virtual environment, character 160 can navigate a digitally rendered landscape, such as a simulation of a cityscape with moving traffic and pedestrians, a fantasy world with dynamic terrain and interactive elements, and/or the like. Virtual environments can be used in video game development, virtual reality (VR) applications, advanced AI training simulations, and/or the like. In a physical environment, the tasks of character 160, such as a humanoid robot, can include navigating real-world scenarios, such as a robot moving through a warehouse to perform logistics operations, maneuvering in a hospital to deliver supplies, operating in hazardous environments such as nuclear facilities where human presence is risky, and/or the like. Sensor(s) 180, such as cameras, light detection and ranging (LIDAR), force sensors, and/or the like, gather real-time data to assist character 160 in adapting to the dynamic conditions of environment 170.

In some embodiments, sensor(s) 180 can include vision sensors, such as stereo cameras, LIDAR systems, and/or the like, that enable character 160 to detect objects, assess distances, and/or perceive the operational environment by providing three-dimensional visual data.

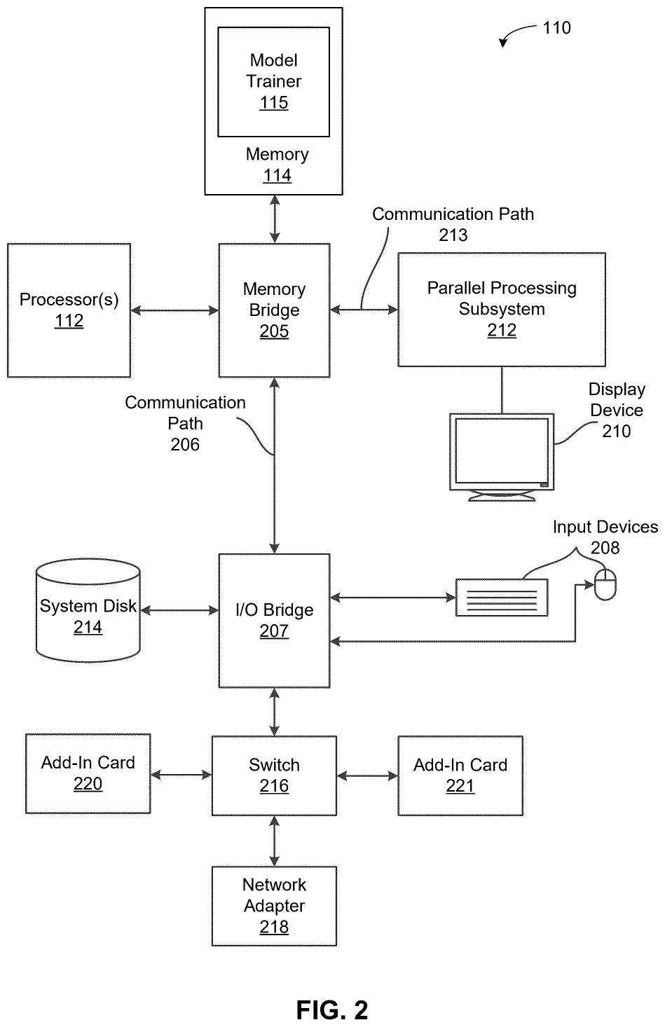

FIG. 2 is a block diagram illustrating machine learning server 110 of FIG. 1 in greater detail, according to various embodiments. Machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In some embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In some embodiments, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, machine learning server 110 may be a server machine in a cloud computing environment. In such embodiments, machine learning server 110 may not include input devices 208, but can receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the machine learning server 110, such as a network adapter 218 and various add in cards 220 and 221.

In some embodiments, I/O bridge 207 is coupled to a system disk 214 that may be configured to store content and applications and data for use by processor(s) 112 and parallel processing subsystem 212. In some embodiments, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to I/O bridge 207 as well.

In some embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point to point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes model trainer 115. Although described herein primarily with respect to model trainer 115, techniques disclosed herein can also be implemented, either entirely or in part, in other software and/or hardware, such as in parallel processing subsystem 212.

In some embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 114 could be connected to processor(s) 112 directly rather than through memory bridge 205, and other devices may communicate with system memory 114 via memory bridge 205 and processor(s) 112. In other embodiments, parallel processing subsystem 212 may be connected to I/O bridge 207 or directly to processor(s) 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add in cards 220, 221 would connect directly to I/O bridge 207. Lastly, in certain embodiments, one or more components shown in FIG. 2 may be implemented as virtualized resources in a virtual computing environment, such as a cloud computing environment. In particular, parallel processing subsystem 212 may be implemented as a virtualized parallel processing subsystem in some embodiments. For example, parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Character Motion Planning and Control

FIG. 3 is a more detailed illustration of model trainer 115 of FIG. 1, according to various embodiments. As shown, model trainer 115 includes, without limitation, motion policy model 152, discriminator 153, a path generator 303, and a reinforcement learning module 304. In operation, model trainer 115 interacts with motion recordings 154 and environment 170 to train motion policy model 152 and discriminator 153.

During training, character 160 (included in environment 170) interacts with environment 170 according to motions generated using a motion policy π included in motion policy model 152, and model trainer 115 updates parameters of motion policy model 152 using a task reward 307 and a discriminative reward 308 that are computed based on the character 160 interactions with environment 170 and based on comparisons of the character 160 interactions with motion recordings 154 by discriminator 15, whose parameters are also updated during the training, respectively. At each step t, control application 146 observes state 301 of environment 170, denoted by sₜ, and samples an action 305 for character 160 to perform, denoted by aₜ, from the motion policy aₜ˜π(aₜ|sₜ). Environment 170 then transitions to the next state sₜ₊₁ based on a transition probability p(sₜ₊₁|sₜ,aₜ). In various embodiments, state 301, denoted by s, includes but is not limited to the pose and speed of character 160, scene information, such as the surrounding height map, and the actions, denoted by a, correspond to motor actuations for character 160. In some examples, character 160 can be a physically animated humanoid interacting within a simulated environment 170. In simulation environment 170, the rules of physics, such as gravity and collisions, ensure the realism of motions generated for character 160. The humanoid is defined by the location and orientation of joints of the humanoid, such as joints associated with the head, torso, arms, and/or the like, and the humanoid can be controlled using proportional-derivative (PD) controllers located in each of the joints. The humanoid dynamics can also follow rigidity and anatomical constraints. In some embodiments, a scene included in state 301 is described as Scene={h, O_{static}, O_{dynamic}, Oₜₒₚ, [symbol] }, where h is the terrain given as a height map h(x,y)∈ [symbol] , specifying the height for each location in grid of environment 170, O_{static} includes a set of non-passable static obstacles, O_{dynamic} includes a set of dynamic obstacles and obstacle dynamics, Oₜₒₚ includes a set of height-limiting (“top”) obstacles requiring character 170 to crouch or crawl when traversing, and [symbol] ={Lᵢ}ᵢ₌₀^{l} includes a set of landmarks. In various embodiments, to successfully move across diverse terrains, height map includes a height grid hₜ representing the height of the terrain around character 160, relative to the global position of character 160 to make motion policy model 152 aware of changes in the terrain around character 160. For example, the height map could include a 64-sample, 8 by 8 height grid spanning 0.8 [m] on each horizontal axis. In some embodiments, when environment 170 is a simulated environment, each time-step of the simulation corresponds to the positions and speeds of all objects in scene and a rendered frame of the scene, which are included in state 301. For every action 305, an actuation is given by the controller on character 160, the location of dynamic obstacles is updated by a pre-specified rule, the simulation advances according to physics to the next time-step, and state 301 gets updated. In at least one example, a task includes a short-horizon XYZ path segment with a fixed time interval between each two subsequent waypoints in the path 302:

$$τ = {( {x}^{t} , {y}^{t} , {z}^{t} )}_{t = 0}^{T} \qquad ( Equation 1 )$$

for a fixed number of samples N∈ [symbol] , sampling rate h, and fixed horizon T=Nh∈ [symbol] N. For example, N=10, h=0.5 s, and T=5 s, which implies that path x is provided as 5 seconds into the future with 10 samples, each 0.5 seconds apart. The higher-level goal includes traveling a desired path 302 between a series of landmarks L₁, . . . , Lₖ according to the order of the landmarks. In at least one example, path 302 is constructed in three dimensions (3D), where at each time step t the point τₜ, represents the 3D coordinates for the head of character 170. By controlling the distance between the points, the requested speed of character 170 can be determined, and changing the Z-axis provides easy control for the requested height of character 170.

Path generator 303 generates one or more path(s) 302 in environment 170. In various embodiments, in order to train motion policy model 152, path generator 170 generates a number of random paths, which can be associated with performing one or more tasks. Generating paths randomly introduces variability in the training scenarios, ensuring that motion policy model 152 can generalize the prediction performance across different situations. In some embodiments, a path can be any obstacle free set of points in two dimensions that character 160 can follow. Each path can include, but is not limited to, straightforward trajectories, such as walking from one side of a room to another in a clutter-free laboratory, or more complex routes involving turns and changes in direction, such as navigating a series of hallways in an office building or dodging furniture in a simulated living space. Additionally, path generator 303 can generate more challenging paths, such as paths requiring the navigation of irregular terrains or dynamic obstacles in environments, such as crowded markets or urban streets, to provide comprehensive training to motion policy model 152. In some embodiments, if the task demands unlikely motion characteristics for character 160, the motion can become unrealistic, such as the task of crawling at v=5 m/s (a fast running speed). In such a case, path generator 303 can sample the requested height for each point along the path. For example, the height could be sampled such that the height is random between 0.4 (crouching) and 1.47 (standing upright), with smooth transitions in-between. Then, the speed can be sampled uniformly between 0 and vₜ^{max}, where:

$${v}_{t}^{m ax} = min ( 1 + 4 \cdot ( {z}_{t} - {z}^{m i n} ) / ( 1.2 - {z}^{m i n} ) , {V}_{m ax} ) , \qquad ( Equation 2 )$$

for a minimal height z^{min}=0.4 m and maximal speed Vₘₐₓ=5 m/s. That is, the maximum speed increases linearly from vₜ^{max}=1 m/s when the requested height is 0.4 m, up to vₜ^{max}=5 m/s for any height above 1.2 m (humanoid height is 1.47 m).

Reinforcement learning module 304 interacts with environment 170, motion policy model 152, and discriminator 153, and reinforcement learning module 304 trains motion policy model 152. In various embodiments, motion policy model 152 is a machine learning model that includes a sparsely-constrained motion controller. In some embodiments, the goal of reinforcement learning module 304 when training motion policy model 152 is to maximize the discounted cumulative reward, defined as

$$J = {𝔼}_{p ( σ \vert π )} [ {\sum }_{t = 0}^{T} {γ}^{t} {r}_{t} \vert {s}_{0} = s ] , \qquad ( Equation 3 )$$

where p(σ|π)=p(s₀)Πₜ₌₀^{T-1}p(sₜ₊₁|sₜ,aₜ)π(aₜ|sₜ) is the likelihood of a trajectory σ=(s₀, a₀, r₀, s_{T-1}, a_{T-1}, r_{T-1}, s_{T}), and γ∈[0,1) is a discount factor that determines the effective horizon of the motion policy model 152. In some embodiments, to find the optimal motion policy π* that maximizes the discounted cumulative reward, reinforcement learning module 304 uses a policy gradient, which directly optimizes motion policy model 152 using the utility of complete trajectories. In some embodiments, reinforcement learning module 304 can use the Proximal Policy Optimization (PPO) algorithm, which gradually improves the motion policy while maintaining stability without drifting too far from the motion policy.

In various embodiments, the reward r^{t} used by reinforcement learning module 304 to update parameters of motion policy model 152 is a sum of task reward 307, denoted by r_{τ}^{t}, and discriminative reward 308, denoted by rₐₘₚ^{t}. In some embodiments, task reward 307 includes two main characteristics that differentiate between desired forms of locomotion—speed and height. In some embodiments, due to the importance of height control, task reward 307 includes four components. The first component considers the x-y displacement of character 160, which guides the path character 160 should follow, in addition to speed. The second component considers the height of the head. The third component considers the direction of the head of character 160 (e.g., pitch and yaw of the head) aligning the head with the path. The fourth component encourages the head of character 160 to be the highest point to prevent a hunchback posture when crouching and crawling given by: rₜ^{body}=c_{body} (z_{head}−max_{body} z) with c_{body}=0.1. In various embodiments, task reward 307 can be described as

$${r}_{t}^{τ} = {e}^{- {c}_{p o s} {‖ {τ}_{t}^{x , y} - {s}_{t}^{x , y} ‖}^{2}} + {e}^{- {c}_{height} {‖ {τ}_{t}^{z} - {s}_{t}^{z} ‖}^{2}} + {e}^{- {c}_{dir} {‖ {τ}_{t}^{y , p} - {s}_{t}^{y , p} ‖}^{2}} + {r}_{t}^{body} , \qquad ( Equation 4 )$$

where cₚₒₛ, c_{height}, and c_{dir} are fixed weights, for example, cₚₒₛ=2, c_{height}=10, and c_{dir}=20. Complementing task reward 307 described above, a discriminative reward 308 is generated by discriminator 153 and is added to task reward 307 to ensure the realism of the generated character motions 306.

Discriminator 153 is a machine learning model that is trained to assess the realism and accuracy of character motions 306. In some embodiments, model trainer 115 uses the Adversarial Motion Prior (AMP) design, in which discriminator 153 is trained to differentiate between motions included in motion recordings 154 and character motions 306 and generate discriminative reward 308 rₐₘₚ^{t}. Discriminative reward 308 in AMP is maximized when the pose distribution induced by motion policy model 152 matches that of the motion recordings 154. In various embodiments, discriminator 153 can be implemented as an artificial neural network. Discriminator 153 evaluates each character motion 306 caused by actions 305 generated by motion policy model 152 and provides feedback in the form of discriminative reward 308 based on the fidelity of the movement in that character motion 306. For example, if the motion policy model 152 generates a sequence of actions 305 where character 160 is supposed to be walking smoothly across a room, but character motion 306 is erratic or unnaturally fast, discriminator 153 would identify discrepancies with the real motions in motion recordings 154 and generate a large discriminative reward 308, which will be added to reward r^{t} used by reinforcement learning module 304. Conversely, character motions 306 that closely mimic the real motions in the motion recordings 154 lead to smaller discriminative reward 308. To train discriminator 153, discriminator 153 receives pairs of motions that each include a real motion included in motion recordings 154 and a character motion 306. Discriminator 153 then repeatedly evaluates the pairs and learns to discern subtle differences in motion quality and generate a discriminative reward 308.

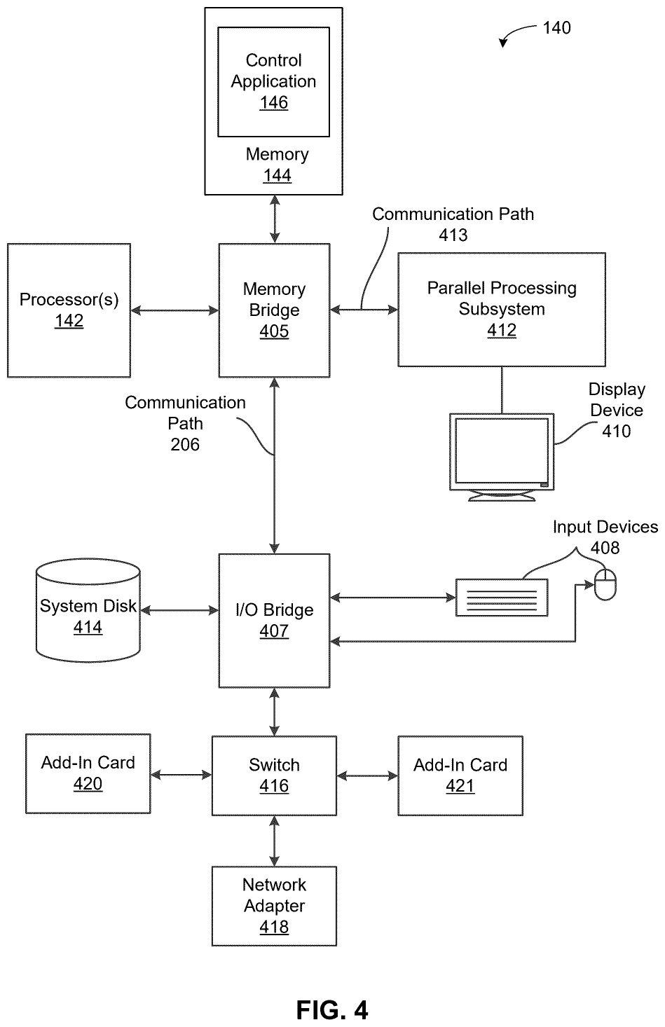

FIG. 4 is a block diagram illustrating computing device 140 of FIG. 1 in greater detail, according to various embodiments. Computing device 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network.

In some embodiments, computing device 140 includes, without limitation, processor(s) 142 and memory(ies) 144 coupled to a parallel processing subsystem 412 via a memory bridge 405 and a communication path 413. Memory bridge 405 is further coupled to an I/O (input/output) bridge 407 via a communication path 406, and I/O bridge 407 is, in turn, coupled to a switch 416.

In some embodiments, I/O bridge 407 is configured to receive user input information from optional input devices 408, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 can be a server machine in a cloud computing environment. In such embodiments, computing device 140 can not include input devices 408, but can receive equivalent input information by receiving commands (e.g., responsive to one or more inputs from a remote computing device) in the form of messages transmitted over a network and received via network adapter 418. In some embodiments, switch 416 is configured to provide connections between I/O bridge 407 and other components of machine learning server 110, such as a network adapter 418 and various add in cards 420 and 421.

In some embodiments, I/O bridge 407 is coupled to a system disk 414 that can be configured to store content and applications and data for use by processor(s) 142 and parallel processing subsystem 412. In some embodiments, system disk 414 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, can be connected to I/O bridge 407 as well.

In some embodiments, memory bridge 405 may be a Northbridge chip, and I/O bridge 407 can be a Southbridge chip. In addition, communication paths 406 and 413, as well as other communication paths within computing device 140, can be implemented using any technically suitable protocols, including, without limitation, AGP (Accelerated Graphics Port), HyperTransport, or any other bus or point to point communication protocol known in the art.

In some embodiments, parallel processing subsystem 412 comprises a graphics subsystem that delivers pixels to an optional display device 210 that may be any conventional cathode ray tube, liquid crystal display, light-emitting diode display, and/or the like. In such embodiments, parallel processing subsystem 412 can incorporate circuitry optimized for graphics and video processing, including, for example, video output circuitry. Such circuitry may be incorporated across one or more parallel processing units (PPUs), also referred to herein as parallel processors, included within parallel processing subsystem 412.

In some embodiments, parallel processing subsystem 412 incorporates circuitry optimized (e.g., that undergoes optimization) for general purpose and/or compute processing. Again, such circuitry may be incorporated across one or more PPUs included within parallel processing subsystem 412 that are configured to perform such general purpose and/or compute operations. In yet other embodiments, the one or more PPUs included within parallel processing subsystem 412 can be configured to perform graphics processing, general purpose processing, and/or compute processing operations. System memory 144 includes at least one device driver configured to manage the processing operations of the one or more PPUs within parallel processing subsystem 412. In addition, system memory 144 includes robot control application 146. Although described herein primarily with respect to robot control application 146, techniques disclosed herein can also be implemented, either entirely or in part, in other software and/or hardware, such as in parallel processing subsystem 412.

In some embodiments, parallel processing subsystem 412 can be integrated with one or more of the other elements of FIG. 2 to form a single system. For example, parallel processing subsystem 412 can be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issues commands that control the operation of PPUs. In some embodiments, communication path 412 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 412, can be modified as desired. For example, in some embodiments, system memory 144 could be connected to processor(s) 142 directly rather than through memory bridge 405, and other devices can communicate with system memory 144 via memory bridge 405 and processor 142. In other embodiments, parallel processing subsystem 412 can be connected to I/O bridge 407 or directly to processor 142, rather than to memory bridge 405. In still other embodiments, I/O bridge 407 and memory bridge 405 can be integrated into a single chip instead of existing as one or more discrete devices. In certain embodiments, one or more components shown in FIG. 2 may not be present. For example, switch 416 could be eliminated, and network adapter 418 and add in cards 420, 421 would connect directly to I/O bridge 407. Lastly, in certain embodiments, one or more components shown in FIG. 2 may be implemented as virtualized resources in a virtual computing environment, such as a cloud computing environment. In particular, parallel processing subsystem 412 can be implemented as a virtualized parallel processing subsystem in some embodiments. For example, parallel processing subsystem 412 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 5 is a more detailed illustration of control application 146 of FIG. 1, according to various embodiments. As shown, control application 146 includes, without limitation, a path planner 503 and trained motion policy model 152. Control application 146 processes textual guidance 501 received from input devices 408 and state 301 from environment 170, and control application 146 generates actions 305 for controlling character 160 in environment 170.

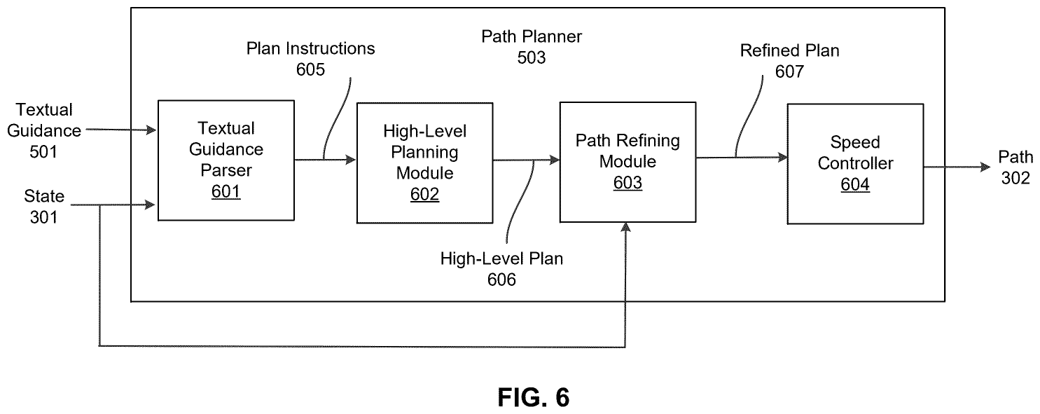

Path planner 503 receives textual guidance 501 and state 301 and generates path 302. In various embodiments, textual guidance 501 includes a series of text instructions describing high-level navigation landmarks and locomotion types, such as, “crouch-walk from the tree to the swing”, in which “crouch-walk” is a locomotion type and “tree” and “the swing” are landmarks, “run from the car to the bench”, in which “run” is a locomotion type and “car” and “bench” are landmarks, and/or the like. In some embodiments, any suitable locomotion types can be specified, such as running, walking, crouching, crawling, skipping, standing, etc. In various embodiments, textual guidance 501 is a templated text instruction describing a sequence of (locomotion type, start point, target point) and refers to known landmarks in the scene included in state 301, and each landmark is assigned a set of (x,y) coordinates corresponding to the location of the landmark. Path planner 503 is described in more detail in conjunction with FIG. 6.

FIG. 6 is a more detailed illustration of path planner 503 of FIG. 5, according to various embodiments. As shown, path planner 503 includes, without limitation, a textual guidance parser 601, a high-level planning module 602, a path refining module 603, and a speed controller 604.

Textual guidance parser 601 is a language processing model that processes textual guidance 501 and state 301 and generates plan instructions 605. For example, for textual guidance 501 “Run from the tree to the lake”, textual guidance parser 601 could identify “Run” as the locomotion type, “tree” as the start point, and “lake” as the target point. In various embodiments, for text parsing, textual guidance parser 601 uses (1) one or more algorithms, such as tokenization, to break down the textual guidance 501 into distinct components, (2) entity recognition (NER) to identify and locate the landmarks within the scene included in state 301, and (3) dependency parsing to understand the relationships between the distinct components. Textual guidance parser 601 then generates plan instructions 605 that can include, but is not limited, to the parsed triplets (source landmark, target landmark, locomotion type). Although described herein primarily with respect to templated text instructions describing sequences of (locomotion type, start point, target point) as a reference example, in some embodiments, a user may provide any suitable text instructions. For example, in some embodiments, a user can provide a natural language instruction that is not in a templated format, and textual guidance parser 601 can prompt a trained language model, such as a large language model (LLM), to generate a templated text instruction from the natural language instruction. Then, textual guidance parser 601 can generate plan instructions 605 from the templated text instruction (or the trained language model can directly generate plan instructions 605).

High-level planning module 602 processes plan instructions 605 and generates high-level plan 606. In various embodiments, high-level planning module 602 uses the A* algorithm to form a 2D grid, connecting each point to eight neighbors of that point. High-level planning module 602 then removes connections where adjacent locations have a height difference above a set threshold or involve static obstacles. For each landmark Lᵢ, high-level planning module 602 assigns (x,y) coordinates as goals. The A* algorithm then constructs the shortest path to the nearest coordinate of each landmark and generates high-level plan 606 that includes the shortest path. In some embodiments, to manage the computational cost, high-level planning module 602 performs the A* algorithm once and uses k-dimensional trees (KD-trees) to store and reuse the computed high-level plan 606. KD-trees quickly locate nearest neighbors and manage spatial data, allowing high-level planning module 602 to reuse previously computed high-level plans 606 for similar plan instructions 605. The reuse reduces computation time and ensures high-level plan 606 is generated relatively quickly, adapting to changes in the environment 170. In various embodiments, the cost function used in the A* algorithm also includes height differences, considering the difficulty and time required for the character to traverse different elevations.

Path refining module 603 processes high-level plan 606 and state 301 and generates refined plan 607. In various embodiments, high-level plan 606 is typically coarse and does not account for dynamic and height obstacles included in state 301, such as an obstacle that the character needs to crawl under. Path refining module 606 refines high-level plan 606 to avoid all obstacles and achieve smoother navigation, thereby generating refined plan 607. In some embodiments, for dynamic obstacles included in state 301, path refining module 603 estimates potential collisions by projecting the movement patterns of dynamic obstacles and comparing the movement patterns of dynamic obstacles with the last point of high-level plan 606. If a collision is predicted to occur within a fixed timeframe (e.g., a 1.5-second timeframe), path refining module 603 replans, incorporating the future positions of dynamic obstacles as constraints. Additionally, path refining module 603 updates the vertical (z-axis) head-height values for each frame to help character 160 navigate beneath height obstacles included in state 301. In various embodiments, path refining module 603 refines high-level plan 606 based on the story of character 160. For example, while a young character can be capable of running a hill, an old character may prefer to take a longer but less physically challenging path. In some examples, path refining module 603 refines high-level plan 606 by re-weighting the connectivity graph based on the slope. For example, path refining module 603 increases the distance between each two points in high-level plan 606 by e^{c-slope}−1.

Speed controller 604 processes refined path 607 and generates path 302. In various embodiments, the objective of speed controller 604 is to minimize motion time of character 160 while adhering to various constraints, such as speed limits, acceleration, curvature, and/or the like. Speed controller 604 assigns a velocity vector to each frame in refined path 607 so that the speeds are consistent with the different locomotion types specified in the text guidance 501 and the terrain characteristics in environment 170. For example, speed controller 604 could generate a path 302 such that character 160 slows down during steep turns to maintain control and avoid displacement errors. In various embodiments, speed controller 604 uses a quadratic programming (QP) solver to optimize the travel time along refined plan 607, considering the maximum acceleration (e.g., 0.5 m/s²) and max deceleration (e.g., −0.1 m/s²), to avoid jerky movements of character 160. The QP solver ensures that the speed at each point of path 302 is within valid ranges for the specific locomotion type and adjusts speeds based on the curvature of refined plan 607 and the elevation at each point of refined plan 607.

FIG. 7 sets forth a flow diagram of method steps for training a motion policy model 152, according to various embodiments. Although the method steps are described in conjunction with the systems of FIGS. 1-6, persons skilled in the art will understand that any system configured to perform the method steps in any order falls within the scope of the present disclosure.

As shown, a method 700 begins at step 701, where model trainer 115 initializes reinforcement learning module 304. The initialization can include, but is not limited, to setting various parameters for reinforcement learning module 304. In various embodiments, model trainer 115 (1) sets the discount factor γ as used in Equation 3, which determines the weight of future rewards compared to immediate rewards; and (2) sets the learning rate, which is used to control how the agent updates the motion policies, for example, in a policy gradient technique. In addition, model trainer 115 initializes the neural network weights in motion policy model 152. In various embodiments, the state and action spaces of character 160 are defined to ensure that motion policy model 152 understands the possible actions 305 that character 160 can take and the conditions of the environment 170 in which character 160 operates. Furthermore, the parameters of the task reward functions as described in Equation 4 cₚₒₛ, c_{body}, c_{dir} and c_{height} are set.

At step 702, path generator 302 generates path(s) 302 for training. Path generator 303 generates a variety of random paths to introduce variability in the training scenarios. Path(s) 302 can be simple, such as walking from one side of a room to another in a clutter-free laboratory, or more complex, involving turns and changes in direction, such as navigating through hallways in an office building or dodging furniture in a simulated living space in environment 170. Path(s) 302 can also include more challenging scenarios, such as navigating irregular terrains or dynamic obstacles in environments, such as crowded markets or urban streets. In some embodiments, Path(s) 302 are defined as sets of obstacle-free points in two dimensions that character 160 can follow. When the task requires unusual motion characteristics, such as crawling at a speed of 5 m/s, path generator 303 adjusts the parameters accordingly. For example, the height for each point along the path could be sampled randomly between 0.4 meters (crouching) and 1.47 meters (standing upright), with smooth transitions in-between. The speed at each point can then be sampled uniformly up to a maximum speed, as described by Equation 2.

At step 703, motion policy model 152 receives path(s) 302 and state 301 and generates actions 305. State 301 includes the pose and speed of character 160, the surrounding height map, and the locations of static and dynamic obstacles. In various embodiments, motion policy model 152 is a neural network which processes path(s) 302 and state 301 and generates actions 305 for character 160. Each action 305 is sampled from the motion policy, aₜ˜π(aₜ|sₜ), where sₜ represents the current state of the environment 170. Actions 305 correspond to, or can be converted into, motor actuations for character 160, which can be a physically or virtually animated humanoid controlled using, e.g., PD controllers located in each joint.

At step 704, motion policy model 152 controls character 160 to perform actions 305 in environment 170. The dynamics of character 160 follow physical laws, such as gravity and collisions, ensuring realism in movements. As character 160 performs actions 305, for example, using PD controllers at every joint, environment 170 transitions to the next state sₜ₊₁ based on a transition probability p(sₜ₊₁|sₜ,aₜ). The transition updates the positions and speeds of all objects, such as character 160 and dynamic obstacles, in scene 301.

At step 705, discriminator 153 receives character motions 306 from environment 170 and generates discriminative reward 308. In various embodiments, discriminator 153 is trained to differentiate between motions included in motion recordings 154 and character motions 306 based on the AMP design, generating discriminative reward 308 (rₐₘₚ^{t}). Discriminative reward 308 in AMP design is maximized when the pose distribution induced by motion policy model 152 matches that of the motion recordings 154. Accordingly, discriminative reward 308 pushes actions generated by motion policy model 152 to be in the style of behaviors in the motion records 154, which can include a curated set of motions corresponding to behaviors (e.g., walking, running, crouching, crawling, standing, skipping, etc.) that the character should be able to perform. In various embodiments, discriminator 153 can be implemented as an artificial neural network, which evaluates each character motion 306 caused by actions 305 generated by motion policy model 152 and provides feedback in the form of discriminative reward 308 based on the fidelity of the movement. To train discriminator 153, discriminator 153 receives pairs of motions that each include a real motion from motion recordings 154 and a character motion 306. Discriminator 153 repeatedly evaluates the pairs, learning to discern subtle differences in motion quality and generating discriminative reward 308.

At step 706, model trainer 115 computes task reward 307. Task reward 307 evaluates how well character 160 adheres to path(s) 302, considering both the speed and the height of character 160. In various embodiments, task reward 307 includes four main components as described in Equation 4: the first component focuses on the x-y displacement, guiding character 160 along the path(s) 302 while maintaining appropriate speed, and the second component addresses the vertical position or head height of character 160 according to path(s) 302. The third component considers the direction of the head of character 160 (e.g., pitch and yaw of the head), aligning the head with the path. The fourth component encourages the head of character 160 to be the highest point to prevent a hunchback posture when crouching and crawling.

At step 707, reinforcement learning module 304 uses task reward 307 and discriminative reward 308 to update motion policy model 152. Reinforcement learning module 304 adds the task reward 307 and discriminative reward 308 and then maximizes the discounted cumulative reward as described in Equation 3, which balances immediate and future rewards to encourage character 160 to carry out actions 305 that are beneficial in the long term. In various embodiments, to optimize the motion policy, reinforcement learning module 304 can use policy gradient techniques, which directly adjust the parameters of the motion policy model 152 based on the gradients of the total expected reward in Equation 3. In some embodiments, reinforcement learning module 304 uses the PPO algorithm, which incrementally improves the policy while ensuring stability and preventing drastic changes. The method then returns to step 702, where a new set of path(s) 302 are generated by path generator 303 and the training process of motion policy model 152 moves to the next epoch. In various embodiments, steps 702 to 707 repeat until a pre-determined number of epochs is reached or the task reward stops improving.

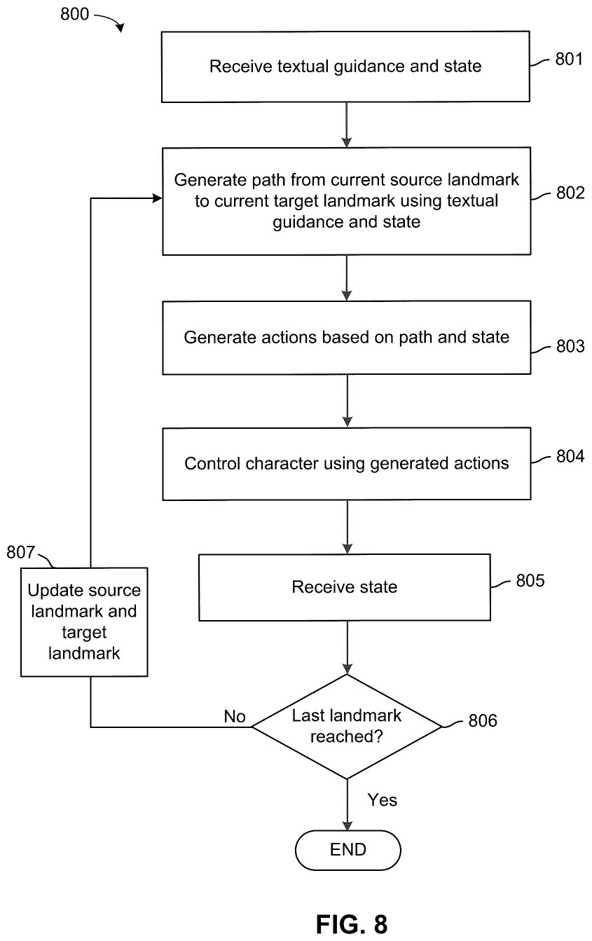

FIG. 8 sets forth a flow diagram of method steps for controlling a character (e.g., character 160) based on a trained motion policy model 152, according to various embodiments. Although the method steps are described in conjunction with the systems of FIGS. 1-6, persons skilled in the art will understand that any system configured to perform the method steps in any order falls within the scope of the present disclosure.

As shown, a method 800 begins at step 801, where path planner 503 receives textual guidance 501 and state 301. Textual guidance 501 includes a series of high-level instructions that describe navigation tasks using specific locomotion types and landmarks. In various embodiments, textual guidance 501 is formatted as templated text, describing sequences of locomotion types, starting landmarks, and target landmarks, referring to a sequence of landmarks L₁, . . . , Lₗ within the scene included in state 301. Each landmark in the instructions is assigned a set of (x, y) coordinates corresponding to the location of the landmark in environment 170.

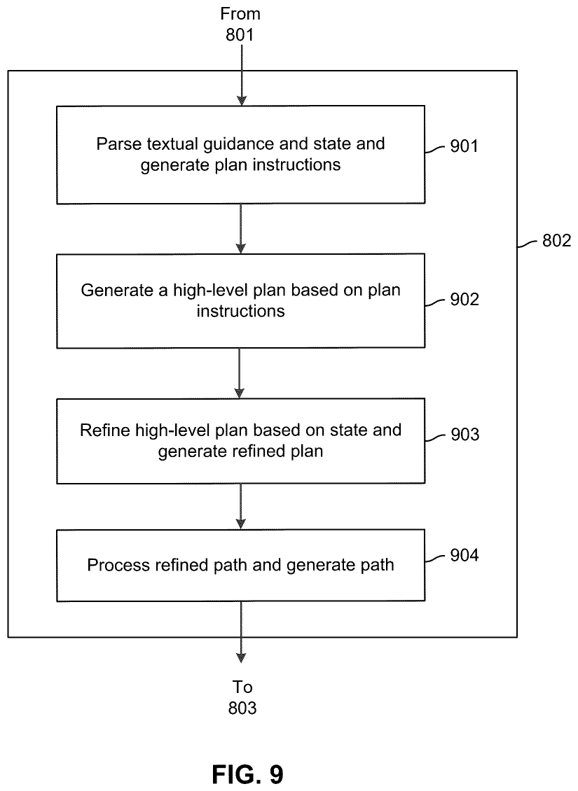

At step 802, path planner 503 generates path 302 from current source landmark to current target landmark using textual guidance 501 and state 301. The generated path 302 consists of a sequence of waypoints as described by Equation 1 that character 160 can follow between a source landmark Lᵢ and a target landmark Lᵢ₊₁, with each waypoint representing the 3D coordinates of the head of character 160 at a specific time. In various embodiments, path planner 302 maintains a fixed time interval between each pair of waypoints in path 302. In some embodiments, path planner 503 controls the speed of character 160 by manipulating the distance between waypoints in path 302. In addition, path planner 503 controls the height of character 160 by varying the Z-coordinate of character 160. The operations performed by path planner 503 are described in more detail in conjunction with FIG. 9.

At step 803, motion policy model 152 generates actions 305 based on path 302 and state 301. In various embodiments, at each step t, motion policy model 152 samples an action aₜ for character 160 to perform from the motion policy π(aₜ|sₜ) based on the current state 301 sₜ of environment 170. In some embodiments, the generated actions 305 correspond to specific motor actuations for character 160, which can include movements of joints in the head, torso, arms, and legs.

At step 804, control application 146 controls character 160 using generated actions 305. In various embodiments, control application 146 uses PD controllers in each joint of character 160 to execute actions 305. In some embodiments, the PD controllers maintain the physical dynamics and anatomical constraints of character 160.

At step 805, path planner 503 receives state 301. In various embodiments, as character 160 executes actions 305, environment 170 transitions to the next state 301 sₜ₊₁ based on a transition probability p(sₜ₊₁|sₜ,aₜ). The transition is governed by the real or simulated rules of physics within environment 170, such as gravity and collisions.

At step 806, control application 146 checks whether the last landmark has been reached. In various embodiments, control application 146 checks whether the distance, such as the Euclidean norm, between (x,y) position of character 160 and the (x,y) position of the last landmark is below a fixed threshold to determine whether the last landmark has been reached. If the last landmark has been reached, the method 800 terminates. If the last landmark has not been reached, the method 800 proceeds to step 807.

At step 807, control application 146 updates the source landmark and the target landmark. In various embodiments, for a sequence of landmarks L₁, . . . , Lₗ and current target landmark Lᵢ, control application 146 selects the previous target landmark Lᵢ as the new source landmark and Lᵢ₊₁ as the next target landmark. The method 800 then proceeds to step 802 so that path planner 503 generates a new path 302 from the updated source landmark to the updated target landmark.

FIG. 9 is a flow diagram of method steps for generating path 302 using textual guidance 501 and state 301, according to various embodiments. Although the method steps are described in conjunction with the systems of FIGS. 1-6, persons skilled in the art will understand that any system configured to perform the method steps in any order falls within the scope of the present disclosure.

As shown, a method 900 begins at step 901, where textual guidance parser 601 parses textual guidance 501 and state 301 and generates plan instructions 605. In some embodiments, textual guidance parser 601, a language processing model, processes textual guidance 501 and the current state 301 of environment 170 and generates plan instructions 605 in the form of (source landmark, target landmark, locomotion type) triplets. For instance, given the textual instruction “Run from the tree to the lake,” textual guidance parser 601 could identify “Run” as the locomotion type, “tree” as the starting landmark, and “lake” as the target landmark. In various embodiments, textual guidance parser 601 uses various natural language processing algorithms. For example, textual guidance parser 601 can use tokenization to break down textual guidance 501 into individual components, named entity recognition (NER) to pinpoint and locate the landmarks within the scene, and dependency parsing to comprehend the relationships between the components.

At step 902, high-level planning module 602 generates high-level plan 606 based on plan instructions 605. In various embodiments, high-level planning module 602 processes plan instructions 605 by first utilizing the A* algorithm to create a 2D grid, connecting each location to eight neighboring locations. High-level planning module 602 then removes connections where the height difference between adjacent locations exceeds a certain threshold or where static obstacles are present. Using the A* algorithm, high-level planning module 602 generates the shortest path to the nearest coordinates of each landmark, forming the high-level plan 606. In some embodiments, to manage computational costs, high-level planning module 602 performs the A* algorithm once and stores the computed high-level plans 606 in KD-trees. In various embodiments, the cost function used in the A* algorithm also includes height differences, considering the difficulty and time required for the character to traverse different elevations.

At step 903, path refining module 603 refines high-level plan 606 based on state 301 and generates refined plan 607. High-level plan 606 often lacks the detail needed to navigate dynamic and height obstacles present in environment 170. Path refining module 603 refines high-level plan 606 and generates refined plan 607, which avoids obstacles and ensures smoother navigation in environment 170. In various embodiments, to handle dynamic obstacles, path refining module 603 projects the movement patterns of dynamic obstacles included in state 301 and compares with high-level plan 606. If path refining module 603 predicts a collision within a fixed timeframe, such as 1.5 seconds, path refining module 603 recalculates plan to incorporate the future positions of dynamic obstacles, including future positions of dynamic obstacles in constraints. Additionally, for height obstacles, path refining module 603 updates the vertical (z-axis) head-height values at each step to ensure character 160 can move under or around static obstacles without collision. In various embodiments, path refining module 603 refines high-level plan 606 based on the story of character 160. In some examples, path refining module 603 refines high-level plan 606 by re-weighting the connectivity graph based on the slope.

At step 904, speed controller 604 processes refined plan 607 and generates path 302. In various embodiments, speed controller 604 minimizes the motion time of character 160 following refined plan 607, while adhering to various constraints such as speed limits, acceleration, curvature, and/or the like. In some embodiments, speed controller 604 assigns a velocity vector to each frame in refined plan 607 to ensure that the speeds are consistent with the different locomotion types specified in textual guidance 501 and the terrain characteristics of environment 170. In various embodiments, to achieve optimal travel time, speed controller 604 uses a QP solver, which considers maximum acceleration and deceleration limits to prevent jerky movements of character 160.

In sum, the disclosed techniques generate motion plans to control a character in an environment. The disclosed techniques include a training step and an inference step. In the training step, a motion policy model is trained in an iterative manner to generate motions for the character based on a given path segment from one landmark to another landmark. The training includes a discriminator and a reinforcement learning module acting in cooperation to train the motion policy model. During the training, the reinforcement learning module generates a motion that is used to control the character in the environment and compute a path-following reward based on the character motion in the environment. The discriminator compares the character motion with stored motion recordings of human motions and generates an AMP reward. A combination of the path-following and the AMP rewards is used to iteratively update both the motion policy model and the discriminator. Once the motion policy model is trained, in the inference step, a path planning technique is performed given an input textual guidance and environment scene to generate a path segment from a source landmark to a goal landmark. The trained motion policy model is then used to generate a motion based on the path segment while checking for collisions with dynamic obstacles. The generated motion can then be used to control the character in the environment, and the foregoing process continues until all target landmarks from the source landmark to the goal landmark are visited.

At least one technical advantage of the disclosed techniques relative to the prior art is that, with the disclosed techniques, a physical or virtual character can be controlled to adapt in real time to unforeseen changes in an environment, unlike conventional approaches that rely on static pre-planned paths. The disclosed techniques adjust to dynamic and unpredictable scenarios where obstacles can appear spontaneously, or terrain can change unexpectedly. Another technical advantage of the disclosed techniques is the ability to generate relatively realistic and naturally accurate motions of characters. Unlike conventional approaches that often generate mechanical and rigid movements, the disclosed techniques enable both path efficiency and human-like motion of characters. These technical advantages represent one or more technological improvements over prior art approaches.

1. In some embodiments, a computer-implemented method for controlling a character comprises receiving a state of the character, a path to follow, and first information about a scene, generating, via a trained machine learning model and based on the state of the character, the path, and the first information, a first action for the character to perform, wherein the first action comprises a first type of motion included in a plurality of types of motions for which the trained machine learning model is trained to generate actions, and causing the character to perform the first action.

2. The computer-implemented method of clause 1, further comprising performing one or more operations to compute the path through at least a portion of the scene.

3. The computer-implemented method of clauses 1 or 2, wherein performing the one or more operations to compute the path comprises performing one or more operations to solve for a two-dimensional (2D) path through the scene, performing one or more operations to refine at least one portion of the 2D path based on one or more heights of one or more obstacles within the scene to generate a three-dimensional (3D) path, and performing one or more operations to compute one or more velocities of the character along the 3D path.

4. The computer-implemented method of any of clauses 1-3, wherein the one or more operations to compute the path are based on a textual instruction and second information about the scene, and wherein the second information indicates at least one of one or more heights within the scene, one or more landmarks within the scene, or one or more obstacles within the scenes.

5. The computer-implemented method of any of clauses 1-4, further comprising generating, via the trained machine learning model and based on a state of the character subsequent to performing the first action, another path, and the first information about the scene, a second action for the character to perform, and causing the character to perform the second action.

6. The computer-implemented method of any of clauses 1-5, further comprising, responsive to determining that the character (i) has reached a goal or (ii) will collide with an obstacle based on an estimated movement of the obstacle and the path, performing one or more operations to compute another path through the scene.

7. The computer-implemented method of any of clauses 1-6, wherein the one or more operations to solve for the 2D path negatively weight larger height differences along the 2D path.

8. The computer-implemented method of any of clauses 1-7, further comprising performing one or more operations to train a first machine learning model to generate the trained machine learning model based on at least one of (i) a first reward based on a displacement between one or more actions generated by the first machine learning model and one or more paths included in training data, (ii) a second reward based on a difference in height between a head of the character during the one or more actions and the one or more paths, (iii) a third reward based on an alignment of a direction of the head of the character during the one or more actions with the one or more paths, (iv) a fourth reward based on the head of the character during the one or more actions being at a highest height, or (v) a fifth reward based on a similarity of the one or more actions to one or more recordings of humans performing the plurality of types of motions.

9. The computer-implemented method of any of clauses 1-8, wherein the second reward is generated by a second machine learning model that is trained simultaneously with the first machine learning model.

10. The computer-implemented method of any of clauses 1-9, wherein the first information comprises a height map.

11. The computer-implemented method of any of clauses 1-10, wherein the character is one of a three-dimensional (3D) virtual character or a physical robot.

12. In some embodiments, one or more non-transitory computer-readable media store instructions that, when executed by at least one processor, cause the at least one processor to perform the steps of receiving a state of the character, a path to follow, and first information about a scene, generating, via a trained machine learning model and based on the state of the character, the path, and the first information, a first action for the character to perform, wherein the first action comprises a first type of motion included in a plurality of types of motions for which the trained machine learning model is trained to generate actions, and causing the character to perform the first action.

13. The one or more non-transitory computer-readable media of clause 12, wherein the instructions, when executed by the at least one processor, further cause the at least one processor to perform the step of performing one or more operations to compute the path through at least a portion of the scene.

14. The one or more non-transitory computer-readable media of clauses 12 or 13, wherein performing the one or more operations to compute the path comprises performing one or more operations to solve for a two-dimensional (2D) path through the scene, performing one or more operations to refine at least one portion of the 2D path based on one or more heights of one or more obstacles within the scene to generate a three-dimensional (3D) path, and performing one or more operations to compute one or more velocities of the character along the 3D path.

15. The one or more non-transitory computer-readable media of any of clauses 12-14, wherein the one or more operations to compute the path are based on a textual instruction and second information about the scene, and wherein the second information indicates at least one of one or more heights within the scene, one or more landmarks within the scene, or one or more obstacles within the scenes.

16. The one or more non-transitory computer-readable media of any of clauses 12-15, wherein the instructions, when executed by the at least one processor, further cause the at least one processor to perform the steps of generating, via the trained machine learning model and based on a state of the character subsequent to performing the first action, another path, and the first information about the scene, a second action for the character to perform, and causing the character to perform the second action.

17. The one or more non-transitory computer-readable media of any of clauses 12-16, wherein the instructions, when executed by the at least one processor, further cause the at least one processor to perform the step of performing one or more operations to train a first machine learning model to generate the trained machine learning model based on at least one of (i) a first reward based on a displacement between one or more actions generated by the first machine learning model and one or more paths included in training data, (ii) a second reward based on a difference in height between a head of the character during the one or more actions and the one or more paths, (iii) a third reward based on an alignment of a direction of the head of the character during the one or more actions with the one or more paths, (iv) a fourth reward based on the head of the character during the one or more actions being at a highest height, or (v) a fifth reward based on a similarity of the one or more actions to one or more recordings of humans performing the plurality of types of motions.

18. The one or more non-transitory computer-readable media of any of clauses 12-17, wherein the plurality of types of motions include at least one of walking, running, crouch-walking, crawling, skipping, or standing.

19. The one or more non-transitory computer-readable media of any of clauses 12-18, wherein the character is one of a three-dimensional (3D) virtual character or a physical robot.

20. The one or more non-transitory computer-readable media of any of clauses 12-19, wherein the character is caused to perform the action in at least one of a simulation environment, a game environment, or a physical environment.

21. In some embodiments, a system comprises one or more memories storing instructions, and one or more processors that are coupled to the one or more memories and, when executing the instructions, are configured to receive a state of the character, a path to follow, and first information about a scene, generate, via a trained machine learning model and based on the state of the character, the path, and the first information, a first action for the character to perform, wherein the first action comprises a first type of motion included in a plurality of types of motions for which the trained machine learning model is trained to generate actions, and cause the character to perform the first action.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a character, the method comprising:
performing one or more operations to solve for a two-dimensional (2D) path through a scene;
performing one or more operations to refine at least one portion of the 2D path based on one or more heights of one or more obstacles within the scene to generate a three-dimensional (3D) path;
computing one or more velocities of the character along the 3D path to generate a first path that includes the one or more velocities; and
causing the character to perform an action based on the first path.

2. The computer-implemented method of claim 1, further comprising, responsive to determining that the character has reached a goal or will collide with a first obstacle based on an estimated movement of the first obstacle and the first path, performing one or more operations to generate a second path through the scene.

3. The computer-implemented method of claim 1, wherein the one or more operations to solve for the 2D path are based on a textual instruction and information about the scene that indicates at least one of one or more heights within the scene, one or more landmarks within the scene, or the one or more obstacles within the scenes.

4. The computer-implemented method of claim 1, wherein the one or more operations to solve for the 2D path negatively weight larger height differences along the 2D path.

5. The computer-implemented method of claim 1, wherein the one or more operations to solve for the 2D path include one or more operations of an A* algorithm, and a cost function of the A* algorithm accounts for one or more height differences.

6. The computer-implemented method of claim 1, wherein the one or more operations to refine the at least one portion of the 2D path is further based on the character.

7. The computer-implemented method of claim 1, wherein the one or more velocities of the character along the 3D path are computed to minimize a motion time of the character and to adhere to one or more constraints.

8. The computer-implemented method of claim 1, further comprising storing the first path using a k-dimensional tree.

9. The computer-implemented method of claim 1, wherein causing the character to perform the action comprises generating the action via a trained machine learning model and based on a state of the character, the first path, and a height map, wherein the action comprises a first type of motion included in a plurality of types of motions for which the trained machine learning model is trained to generate actions.

10. The computer-implemented method of claim 1, wherein the character is one of a three-dimensional (3D) virtual character or a physical robot.

11. One or more non-transitory computer-readable media storing instructions that, when executed by at least one processor, cause the at least one processor to perform the steps of:
performing one or more operations to solve for a two-dimensional (2D) path through a scene;
performing one or more operations to refine at least one portion of the 2D path based on one or more heights of one or more obstacles within the scene to generate a three-dimensional (3D) path;
computing one or more velocities of the character along the 3D path to generate a first path that includes the one or more velocities; and
causing the character to perform an action based on the first path.

12. The one or more non-transitory computer-readable media of claim 11, wherein the instructions, when executed by the at least one processor, further cause the at least one processor to perform the step of, responsive to determining that the character has reached a goal or will collide with a first obstacle based on an estimated movement of the first obstacle and the first path, performing one or more operations to generate a second path through the scene.

13. The one or more non-transitory computer-readable media of claim 11, wherein the one or more operations to solve for the 2D path negatively weight larger height differences along the 2D path.

14. The one or more non-transitory computer-readable media of claim 11, wherein the one or more operations to solve for the 2D path include one or more operations of an A* algorithm, and a cost function of the A* algorithm accounts for one or more height differences.

15. The one or more non-transitory computer-readable media of claim 11, wherein the one or more velocities of the character along the 3D path are computed to minimize a motion time of the character and to adhere to one or more constraints.

16. The one or more non-transitory computer-readable media of claim 15, wherein the one or more constraints include at least one of a speed limit, an acceleration constraint, or a curvature constraint.

17. The one or more non-transitory computer-readable media of claim 11, wherein the three-dimensional (3D) path avoids the one or more obstacles.

18. The one or more non-transitory computer-readable media of claim 11, wherein performing one or more operations to refine the at least one portion of the 2D path comprises re-weighting a connectivity graph associated with the 2D path based on a slope.

19. The one or more non-transitory computer-readable media of claim 11, wherein causing the character to perform the action comprises generating the action via a trained machine learning model and based on a state of the character, the first path, and a height map, wherein the action comprises a first type of motion included in a plurality of types of motions for which the trained machine learning model is trained to generate actions.

20. A system, comprising:
one or more memories storing instructions; and
one or more processors that are coupled to the one or more memories and, when executing the instructions, are configured to:
perform one or more operations to solve for a two-dimensional (2D) path through a scene,
perform one or more operations to refine at least one portion of the 2D path based on one or more heights of one or more obstacles within the scene to generate a three-dimensional (3D) path,
compute one or more velocities of the character along the 3D path to generate a first path that includes the one or more velocities, and
cause the character to perform an action based on the first path.
